(19) United States
(12) Patent Application Publication
(10) Pub. No.: US 2013/0276045 A1
(43) Pub. Date: Oct. 17, 2013

(54) ELECTRONIC DEVICE, CONTROL METHOD AND COMPUTER-READABLE MEDIUM

(71) Applicant: KABUSHIKI KAISHA TOSHIBA, Tokyo (JP)

(72) Inventor: Yukiya Ono, Hamura-shi (JP)

(73) Assignee: KABUSHIKI KAISHA TOSHIBA, Tokyo (JP)

(21) Appl. No.: 13/780,522

(22) Filed: Feb. 28, 2013

(30) Foreign Application Priority Data
Apr. 12, 2012 (JP) 2012-091232

(51) Int. Cl. H04N 21/437

(52) U.S. Cl. CPC H04N 21/437
USPC 725/110

(57) ABSTRACT

In one embodiment, there is provided an electronic device. The electronic device includes: a first receiver configured to receive a broadcast program; a second receiver configured to receive a certain signal from another electronic device; a first detector configured to detect that the second receiver has received the certain signal from said another electronic device; a posting information acquiring module configured to acquire a preset posting information, when the first detector detects that the second receiver has received the certain signal from said another device; and a posting information output module configured to output the preset posting information as posting information of the received broadcast program to a predetermined server.

### CROSS-REFERENCE TO RELATED APPLICATION

This application claims priority from Japanese Patent Application No. 2012-091232, filed on Apr. 12, 2012, the entire contents of which are hereby incorporated by reference.

### BACKGROUND

1. Field

Embodiments described herein relate to an electronic device, a control method, and a computer-readable medium.

2. Description of the Related Art

In recent years, social networking service (SNS) has been widely spread.

The SNS is a service that allows users to interact over a social network on the Internet.

Users can access the SNS with an electronic device such as a PC or a portable terminal.

The SNS contributes to promote communication between people to provide a new personal relationship by way of connecting with people, for example, via a blog posting function.

Further, as an electronic device such as the TV (television) receiver configured to receiver the broadcast program has been accessible to the Internet, users have had a need for posting comments on the SNS while viewing the broadcast programs.

For instance, there is known a technique for posting blog on a SNS server using remote controller capable of operating the electronic device such as the TV.

However, when posting the comments about the broadcast programs on the SNS, a synchronization of the remote controller with the TV is required before posting the comments on the SNS. For this reason, it is hard to make a system with simple configuration.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention:

FIG. 1 is a diagram illustrating an external appearance of an electronic device (TV) according to an exemplary embodiment of the present invention;

FIG. 2 is a block diagram illustrating a configuration of the electronic device (TV) according to the exemplary embodiment;

FIG. 3 is a diagram illustrating a remote controller used in the electronic device (TV) according to the exemplary embodiment;

FIG. 4 is an explanatory diagram illustrating an operation of the electronic device (TV) according to the exemplary embodiment;

FIGS. 5A-5D are diagrams illustrating posting information setting screens displayed on a screen of the electronic device (TV) according to the exemplary embodiment;

FIG. 6 is a flow chart illustrating an operational process in which the posting information is set in the electronic device (TV) according to the exemplary embodiment;

FIG. 7 is a flow chart illustrating an operational process of extracting and outputting the received broadcast programs based on the posting information settings in the electronic device (TV) according to the exemplary embodiment; and

FIG. 8 is a flow chart illustrating another operational process for extracting and outputting posting information of the received broadcast program based on the set posting information in the electronic device (TV) according to the exemplary embodiment.

### DETAILED DESCRIPTION

According to exemplary embodiments of the present invention, there is provided an electronic device. The electronic device includes: a first receiver configured to receive a broadcast program; a second receiver configured to receive a certain signal from another electronic device; a first detector configured to detect that the second receiver has received the certain signal from said another electronic device; a posting information acquiring module configured to acquire a preset posting information, when the first detector detects that the second receiver has received the certain signal from said another device; and a posting information output module configured to output the preset posting information as posting information of the received broadcast program to a predetermined server.

Hereinafter, exemplary embodiments of the present invention will be described with reference to the accompanying drawings.

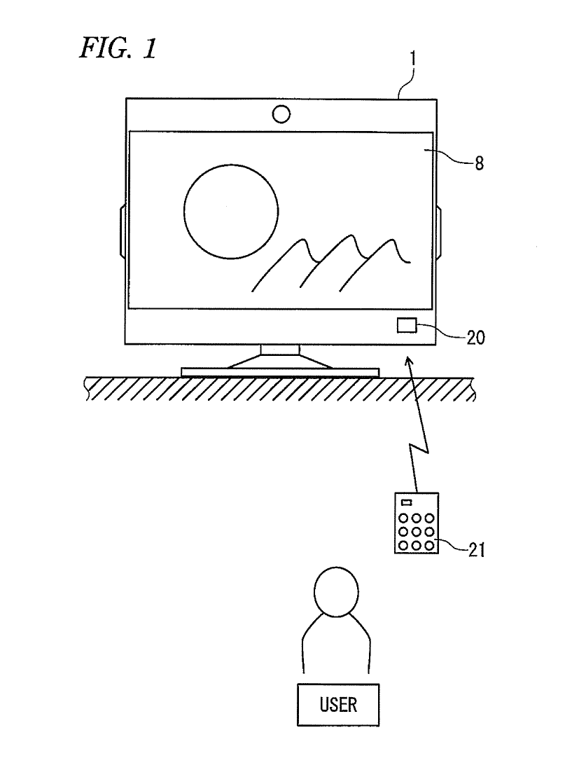

FIG. 1 illustrates an external appearance of an electronic device (TV) the according to an exemplary embodiment of the present invention.

A TV is illustrated as an example of an electronic device 1 (for example, TV receiver, hereinafter the electronic device 1 is referred to as TV receiver 1) in the exemplary embodiment. However, a PC or portable terminal may also be adapted to implement the exemplary embodiment.

In this embodiment, a TV receiver 1 is operated according to a operation of a remote controller 21 by a user. A remote control signal output from the remote controller 21 is received by an operation receiver 20 of the TV receiver 1.

The TV receiver 1 receives the remote control signal, and then is operated according to an instruction by the remote control signal to display a predetermined image on a screen (an image display module) 8. The image display module 8 is, for example, a liquid crystal display (LCD).

The TV receiver 1 includes an external storage device (e.g., HDD) (not shown) which can be externally attached thereto via a USB terminal and the like. Further, for instance, a broadcast received by the TV receiver 1 may be recorded on the external storage device.

The TV receiver 1 includes a battery (not shown) which is either connected thereto or built therein.

The battery can be charged by electricity supplied from a commercial power source.

The TV receiver 1 is normally operated by electricity supplied from the commercial power source (e.g., AC power source which is not shown). However, when the TV receiver 1 is unable to receive the electricity from the commercial power source, for example, due to a power failure of the commercial power source, an operation of the TV receiver 1 is made possible by electricity supplied from the battery 30 instead of the commercial power source.

In this embodiment, the TV receiver 1 receives a broadcast program, for example, using a tuner 3 to be described below, and outputs the broadcast program on, for example, the screen 8.

The user viewing the broadcast program may want to post contents about the broadcast program on SNS, but may not want to stop viewing the broadcast program.

In this embodiment, the TV receiver 1 has a preset posting function and is configured to set contents which the user wants to post (e.g., posting information or posting contents), for example, according to a operation of the remote controller 21 by a user, as described below.

For example, when the user depresses a comment key (tweet key) 33 on the remote controller 21, the remote controller 21 outputs a predetermined signal corresponding to the comment key 33.

The TV receiver 1 detects receipt of the preset signal (e.g., the predetermined signal output from the remote controller 21).

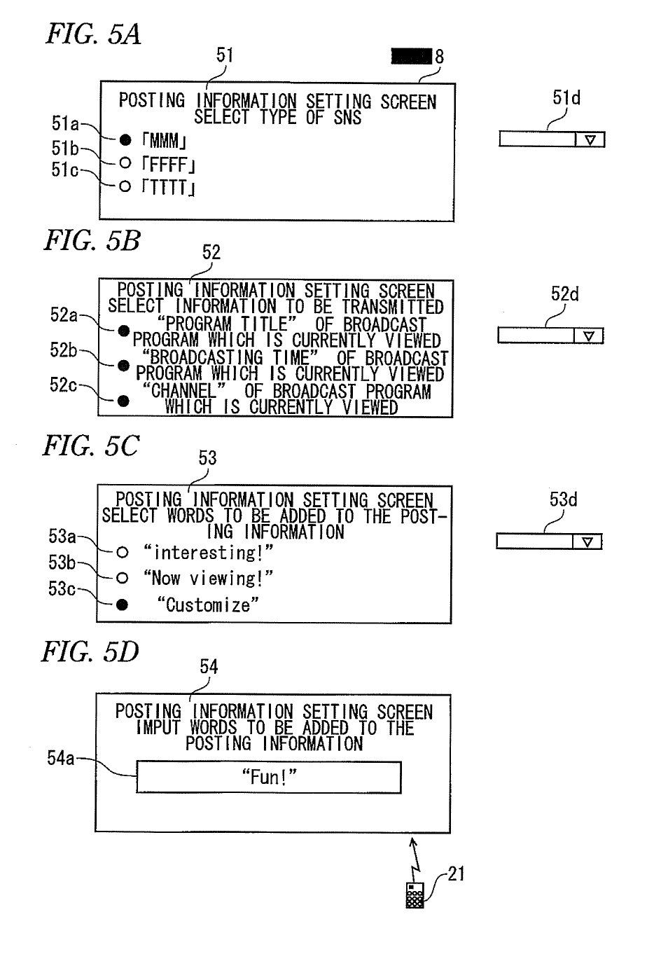

When the receipt of the preset signal is detected, the TV receiver 1 acquires posting information (see FIGS. 5A-5D) which is preset therein.

The TV receiver 1 extracts and outputs posting information about the received broadcast program based on the settings.

In addition, the TV receiver 1 includes the screen 8, however, for example, the TV receiver 1 and the screen 8 may be configured as separate components.

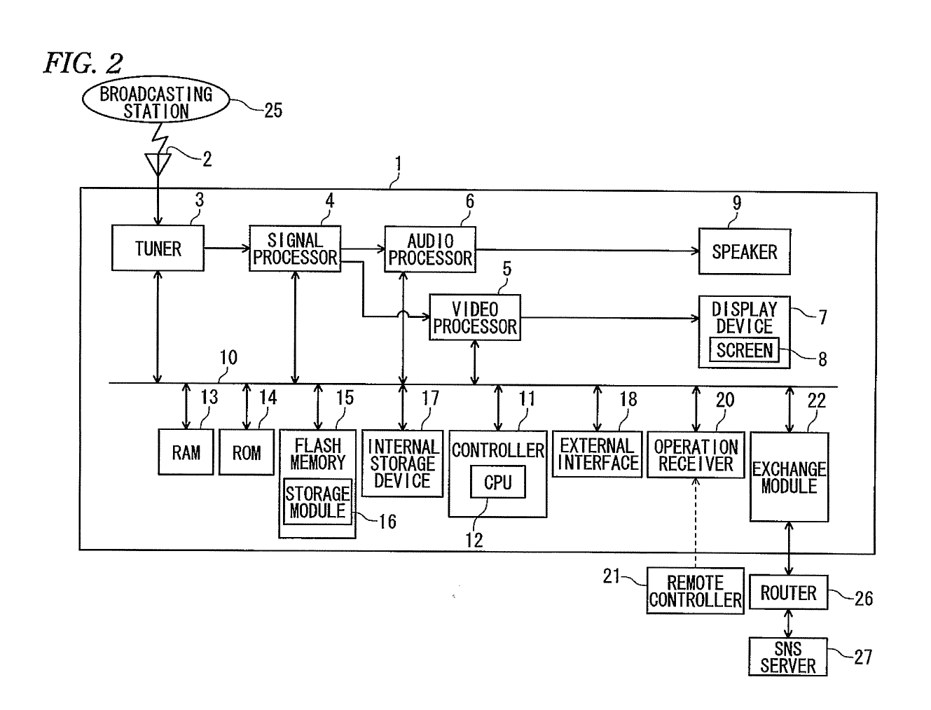

FIG. 2 is a block diagram illustrating a configuration of the electronic device according to the exemplary embodiment.

In the exemplary embodiment, the controller 11 includes a CPU 12 which controls the TV receiver 1. A RAM 13, a ROM 14, and a flash memory 15 are used for processing performed in the controller 11.

For example, image contents (program) are broadcasted over digital broadcasts from a broadcasting station 25. The digital broadcasts (broadcast programs) broadcasted from the broadcasting station 25 are received by a tuner 3, and a channel selection is performed so that the image contents of the digital signal are transmitted to the signal processor 4.

The image contents of the digital signal received by the signal processor 4 are subject to the signal processing and then transmitted to a voice processor 6 and an video processor 5.

The audio processor 6 receives image contents on which the signal processing is performed and transmits the signal on which the voice processing is performed to a speaker 9.

The speaker 9 receives a signal on which the voice processing is performed and outputs voice.

The video processor 5 receives the image contents on which the signal processing is performed and transmits the signal on which the image processing is performed to the display device 7.

The display device 7 receives the signal on which the image processing is performed and displays the image on the screen (image display module) 8 configured by, for example, an LCD panel.

In the exemplary embodiment, the TV receiver 1 includes an internal storage device 17 which records the received broadcasting programs.

The TV receiver 1 may record the received image contents in the external storage device 19 connected through a USB or a LAN, as described above.

As described above, the operation of the TV receiver 1 by the user is instructed by an operation device such as the remote controller 21.

The above processing is controlled by the controller 11.

The TV receiver 1 may make a social networking system (SNS) when the TV receiver 1 is connected with a SNS server 27 through a data exchange module (e.g., LAN) 22 and a router (the Internet) 26.

In a broad sense, a service or a web site capable of making a social network is defined as a social networking service or a social networking site.

Accordingly, a blog having communication functions such as comments or trackback may also be regarded as a social networking service.

Herein, the trackback refers to one of the principal functions of the blog by which the user creates a link of an article written on others' blog to the users' blog.

Furthermore, the trackback may indicate an action itself which utilizes the trackback function.

A blog, in a narrow sense, is a sort of a webpage having a memo or comment logged (recorded) thereon along with an URL of a web page on the World Wide Web. The blog is named as Weblog in the meaning of ┌Log a Web┘, and it has been said that the meaning is abbreviated to be referred to as a blog.

The social networking service, in a narrow sense, is defined as a community-type membership service which facilitates and supports connection between people, and a website providing the community-type membership service is also included.

A social networking service intends to provide a communication between people and provides a new human relationship through the connection with other people who do not have direct relationship with the user, such as a means, places, hobbies, tastes, residential area, users' alma master, Friend Of A Friend for facilitating communication with friends or acquaintances.

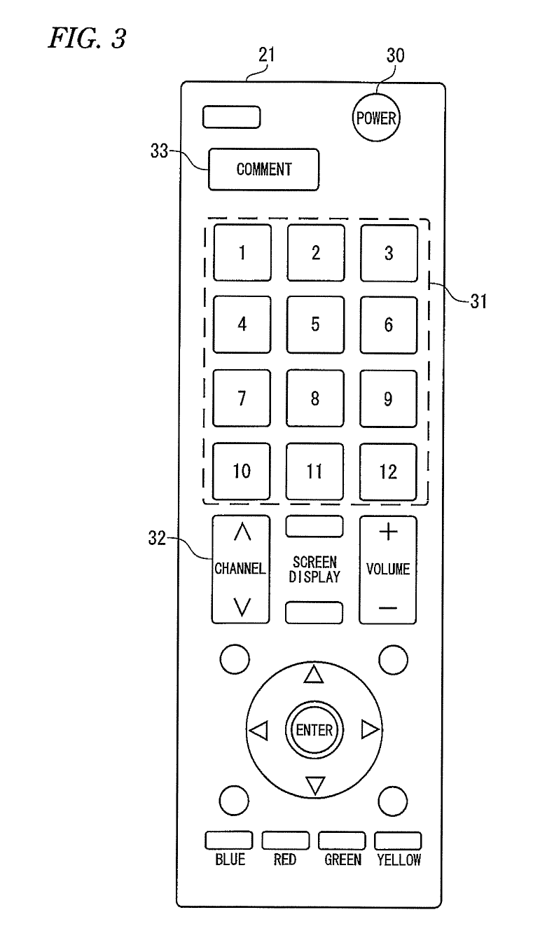

FIG. 3 is a view of illustrating an example of a remote controller utilized in an image output apparatus according to the exemplary embodiment.

As shown in FIG. 3, a remote controller 21 includes a power source button 30, numeric key 31, and a channel up-down key 32. The numeric key 31 and a channel up-down key 32 are used in switching operation of broadcast receiving channel, and is referred to as, for example, channel switch keys.

In this embodiment, a remote controller 21 is provided with a comment key 33.

The comment key 33 is a dedicated key for the remote controller 21.

As described above, when the comment key 33 is depressed by the user, a predetermined remote control signal is output toward the TV receiver 1.

The TV receiver 1 obtains preset posting information according to the receipt of the remote control signal, and extracts the posting information about the received broadcast program based on the preset posting information and then outputs the extracted information toward the SNS server 27.

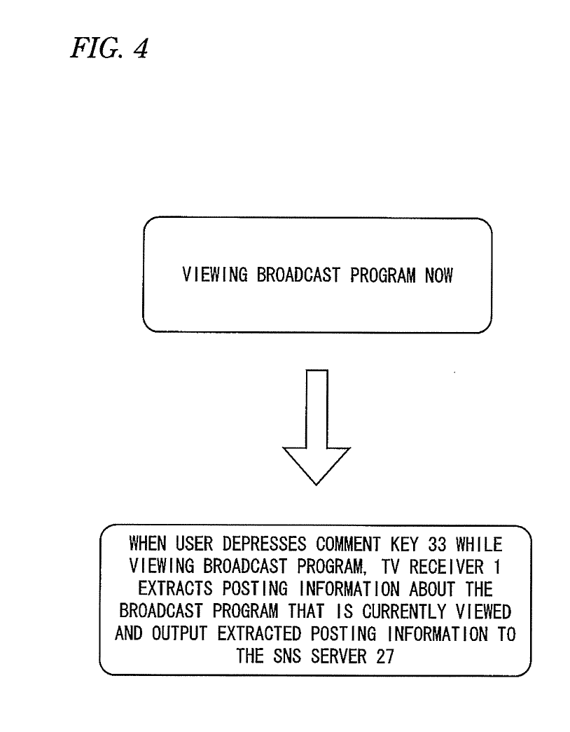

FIG. 4 is an explanatory diagram illustrating an operation of the TV receiver 1 according to the exemplary embodiment.

As illustrated in FIG. 4, when a user depresses the comment key 33 while viewing a broadcast program, the TV receiver 1 extracts posting information about the broadcast program that is currently viewed and outputs the extracted posting information to the SNS server 27. That is, program information is automatically outputted to the SNS server 27.

FIGS. 5A-5D are diagrams illustrating posting information setting screens displayed on a screen of the TV according to the exemplary embodiment.

Although not illustrated specifically, the user operates the remote controller 21 to display the posting information setting screen on screen 8 as illustrated in FIGS. 5A-5D.

FIG. 5A depicts a screen for selecting SNS type.

In FIG. 5A, “MMM” 51a, “FFFF” 51b, “TTTT” 51c are displayed as selectable SNS types.

As illustrated in FIG. 5A, The “MMM” 51a has been selected herein.

Further, a selection display scheme is not limited to such a scheme as described above and, for example, can be made as illustrated in the reference numeral 51d.

FIG. 5B depicts a screen for selecting information which is to be transmitted to the SNS server 27.

In FIG. 5B, program title 52a, broadcasting time 52b and channel 52c of the broadcast program that is currently viewed are displayed as selectable transmission information.

As illustrated in FIG. 5B, the program title 52a, the broadcasting time 52b and the channel 52c of the broadcast program that is currently viewed have been selected.

Further, a selection display scheme is not limited to such a scheme as described above, and, for example, can be made as illustrated in the reference numeral 52d.

FIG. 5C depicts a screen for selecting words to be added to the posting information.

In FIG. 5C, “interesting!” 53a, “Now viewing!” 52b and “Customize” 52c are displayed as words to be added to the posting information.

As illustrated in FIG. 5C, the “Customize” 52c has been selected.

Further, a selection display scheme is not limited to such a scheme as described above, and, for example, can be made as illustrated in the reference numeral 53d.

FIG. 5D depicts a screen for adding words to the posting information.

In FIG. 5D, “Fun!” 54a is input by the user and displayed as words to be added to the posting information.

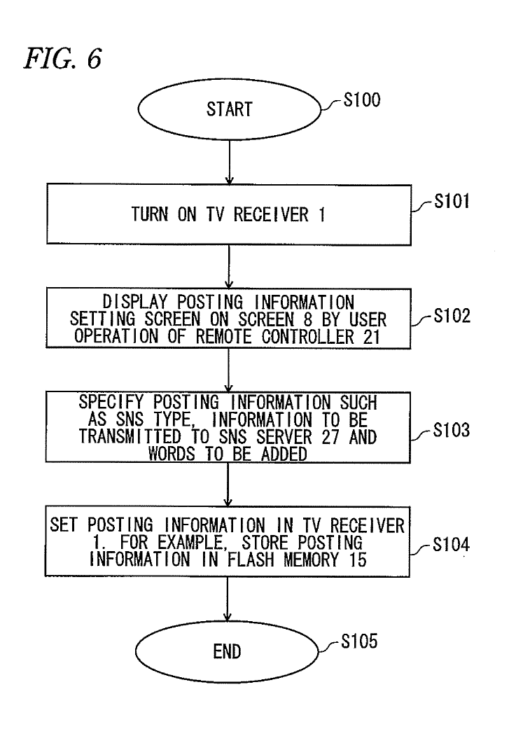

FIG. 6 is a flow chart illustrating how the posting information is set in the TV receiver 1 according to the exemplary embodiment.

The process starts from step S100, and subsequently proceeds to step S101.

At step S101, the TV receiver 1 is turned ON. Subsequently, the process proceeds to step S102.

At step S102, the posting information setting screen is displayed on screen 8 by a user operation of the remote controller 21. Subsequently, the process proceeds to step S103.

At step S103, the user specifies posting information such as SNS type, information to be transmitted to the SNS server 27 and words to be added. Subsequently, the process proceeds to step S104.

At step S104, the posting information is set in the TV receiver 1. For example, the posting information may be stored in the flash memory 15. Subsequently, the process proceeds to step S105.

At step S105, the process is ended.

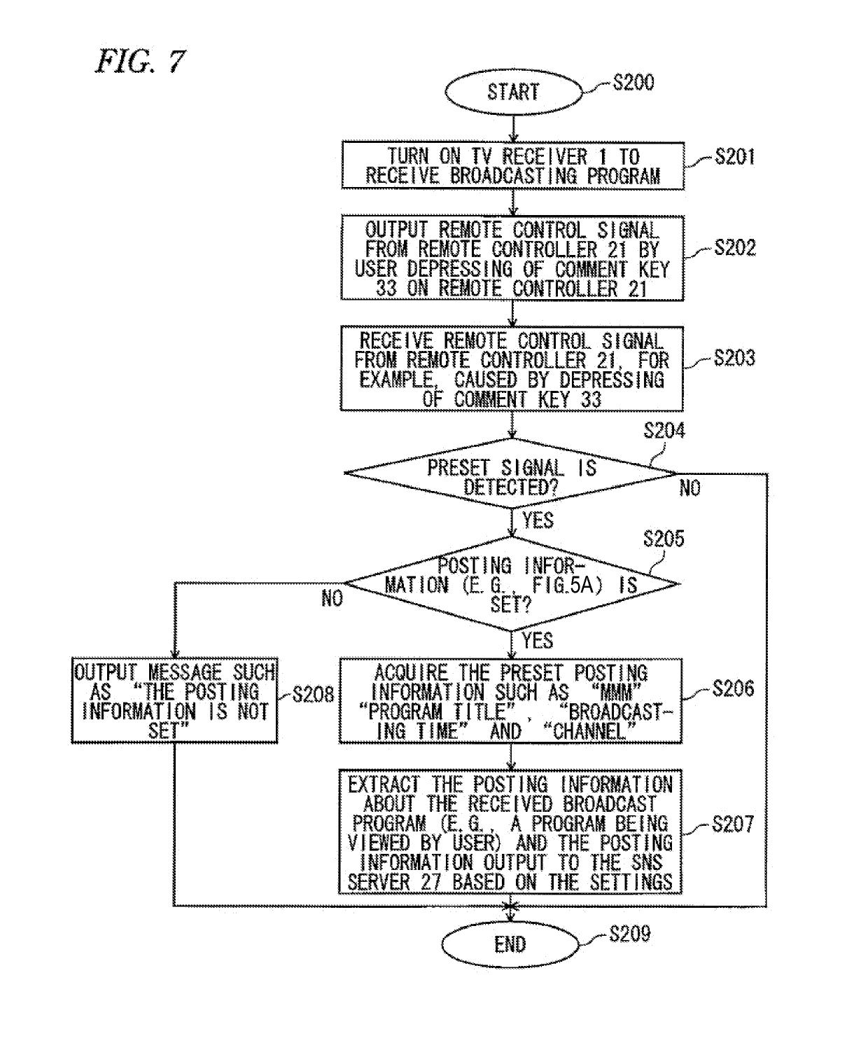

FIG. 7 is a flow chart illustrating an operational process of extracting and outputting posting information of the received broadcast programs based on the posting information settings in the TV according to the exemplary embodiment.

The process starts from step S200, and subsequently proceeds to step S201.

At step S201, the TV receiver 1 is turned ON to receive the broadcasting program as described above. Subsequently, the process proceeds to step S202.

At step S202, the remote control signal is output from the remote controller 21 by the user depressing of the comment key 33 on the remote controller 21. Subsequently, the process proceeds to step S203.

At step S203, the TV receiver 1 receives the remote control signal from the remote controller 21, for example, caused by depressing of the comment key 33. Subsequently, the process proceeds to step S204.

At step S204, it is determined whether the receipt of signal generated by depressing of the comment key 33, that is, whether a preset signal is detected. If it is determined that the receipt of signal is detected (“Yes” at step 204), the process proceeds to step S205. If it is determined that the receipt of signal is not detected (“No” at step 204), the process proceeds to step S209.

At step S205, it is determined whether the posting information is set in the TV receiver 1 as illustrated in FIG. 5A. If it is determined that the posting information is set (“Yes” at step 205), the process proceeds to step S206. If it is determined that the posting information is not set (“No” at step 205), the process proceeds to step S208.

At step S206, the TV receiver 1 acquires the preset posting information. For example, as illustrated in FIG. 5A, “MMM” is set as a SNS type, and the transmission information to be transmitted to the SNS server, such as “program title”, “broadcasting time” and “channel” are indicated as settings. Subsequently, the process proceeds to step S207.

At step S207, the posting information about the received broadcast program (e.g., a program being viewed by user) is extracted and outputted to the SNS server 27, based on the settings.

Furthermore, the information such as “program title”, “broadcasting time” and “channel” may be obtained from, for example, an EPG information of the received broadcast program.

As one of the EPG information, there is an electronic program list of the broadcast programs transmitted through broadcast.

The EPG is a sort of information in which programs broadcasted from broadcasting station is arranged in a table format. For example, a program title, starting time and ending time of the broadcast program are described in the EPG. Further, it may be described in the EPG that the name of casts, distinction between, for example, mono, stereo, or bilingual broadcast, the existence of subtitles, a production country or organization, year or information about event, and the like for a new broadcast program, a special program, or a cinema.

Subsequently, the process proceeds to step S209.

At step S208, a message such as “The posting information is not set” is output. Subsequently, the process proceeds to step S209.

At step S209, the process is ended.

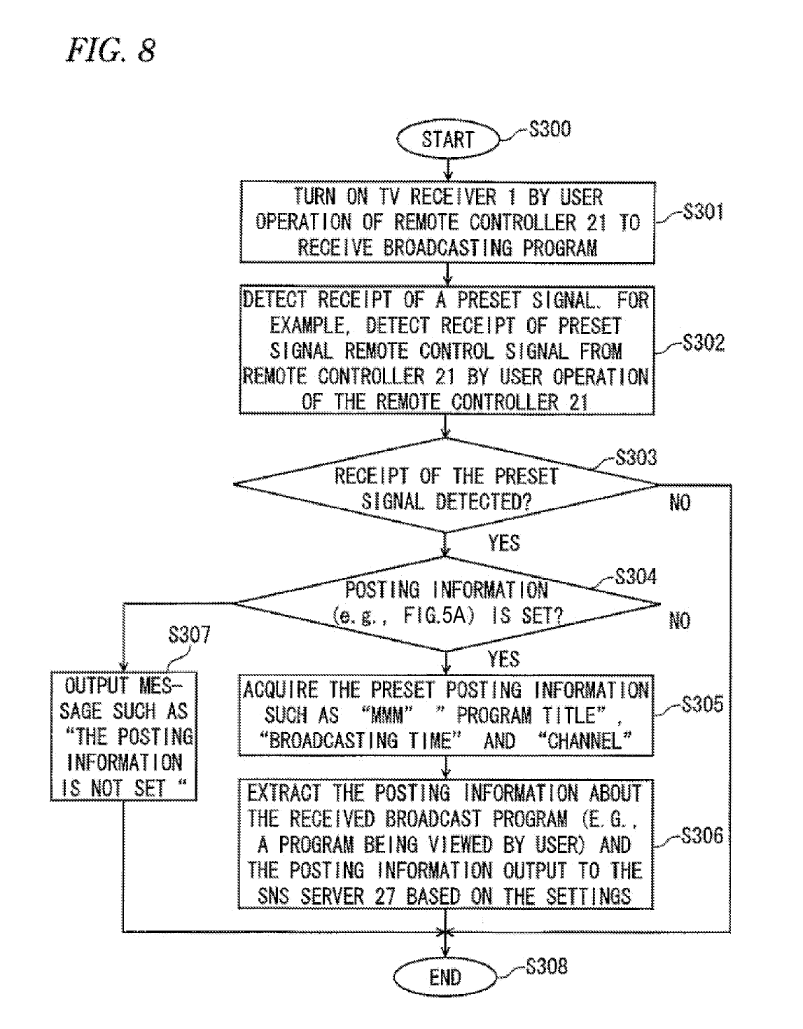

FIG. 8 is a flow chart illustrating an operational process of extracting and outputting the posting information of the received broadcast program based on the preset posting information in the TV according to another exemplary embodiment.

In the exemplary embodiment, for example, when receiving an indication signal for a preset operation (e.g., turning ON/OFF of power source, channel change, depressing of SNS key 33 on the remote controller 21, etc.), the TV receiver 1 extracts the posting information of the received broadcast program and outputs the extracted information to the SNS server 27.

The process starts from step S300, and subsequently proceeds to step S301.

At step S301, the TV receiver 1 is turned ON by a user operation of the remote controller 21 to receive a broadcasting program which the user wants to view. Subsequently, the process proceeds to step S302.

At step S302, receipt of a preset signal is detected. For example, the receipt of the preset signal of the remote control signal from the remote controller 21 by a user operation of the remote controller 21 is detected.

This user operation of the remote controller 21 may includes, for example, turning ON/OFF of the power source, channel change, depressing of SNS key 33 on the remote controller 21, and the like. Subsequently, the process proceeds to step S303.

At step S303, receipt of the preset signal is detected. If the receipt of the preset signal is detected (“Yes” at step 303), the process proceeds to step S304. If the receipt of the preset signal is not detected (“No” at step 303), the process proceeds to step S308.

At step S304, it is determined whether the posting information as illustrated in FIG. 5A is preset in the TV receiver 1. If it is determined that the posting information is preset (“Yes” at step 304), the process proceeds to step S305. If it is determined that the posting information is not preset (“No” at step 304), the process proceeds to step S307.

At step S305, the TV receiver 1 obtains the preset posting information. The preset posting information includes information, for example, “MMM” which is set as a SNS type, and the transmission information, such as “program title”, “broadcasting time” and “channel”, and the like. Subsequently, the process proceeds to step S306.

At step S306, the posting information about the received broadcast program is extracted and outputted to the SNS server 27, based on the settings. Subsequently, the process proceeds to step S308.

At step S307, a message such as “The posting information is not set” is output. Subsequently, the process proceeds to step S308.

At step S308, the process is ended.

The TV receiver 1 according to the exemplary embodiment includes a receiver (e.g., tuner 3) that receives a broadcasting program.

The TV receiver 1 includes a signal receipt detector (e.g., a controller 11) for detecting receipt of a preset signal.

The TV receiver 1 includes posting information acquiring module (e.g., the controller 11) configured to acquire a preset posting information when the receipt of the preset signal is detected.

The TV receiver 1 further includes posting information output module (e.g., the controller 11 and a data exchange module 22) configured to extract and output posting information of the posting information of the received broadcast information based on the settings.

The TV receiver 1 further includes a storage module 16 (e.g., a flash memory 15) that stores the preset posting information therein.

The TV receiver 1 further includes a settings detector (e.g., the controller 11) that stores the preset posting information.

The TV receiver 1 further includes a first operation key (e.g., comment key 33) and receives a signal from the remote controller 21 (e.g., an operation receiver, the controller 11) that outputs a preset signal when the first operation key is operated.

The preset signal includes a signal which instructs any of posting, turning ON/OFF of power source and changing of receiving channel.

The TV receiver 1 further includes a specifying module (see a posting information setting screen display on the screen 8 in FIG. 5A) configured to specify the posting information.

In the above-described exemplary embodiment, the TV receiver 1 has an automatic posting function by a setting scheme described above. As such, a user may simply post information without using PC and the like.

In the TV receiver 1, a user can post the information to SNS while viewing the broadcast program.

The user may extract broadcast information of the broadcast program and add the extracted information when posting information on SNS.

In another exemplary embodiment, the information may be automatically posted by turning ON the TV receiver 1. In this case, for example, a comment such as “Now viewing!” may be added to the posting.

In yet another exemplary embodiment, the information may be automatically posted when a receiving channel is changed. In this case, for example, a comment such “Now viewing TV channel X!” may be added to the posting.

In still yet another exemplary embodiment, the information may be automatically posted when depressing a specific button on the remote controller. In this case, for example, a comment such as “XXXX is interesting!” may be added to the posting.

In another exemplary embodiment, the information may be automatically posted by turning OFF the TV receiver 1. In this case, for example, a comment such as “This TV program was interesting!” may be added to the posting.

With the configuration described above, the user can post information while viewing a broadcasting program. Further, it is possible to post, that is, set contents of the comment in advance, in accordance with a user operation (depression of the remote control key 33, the power source key 30 and the like).

It is also possible to set posting words according to user's preference.

With the configuration described above, it is also possible to reduce the system complexity in an electronic device having a posting function on the SNS system.

Also, all of the control sequences of the exemplary embodiments may be executed by software. Therefore, it is possible to easily realize the same effect as the exemplary embodiment only by executing a program installed in a computer through a computer readable recording medium in which the program that executes the control sequences is stored.

While certain embodiments have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the sprit of the invention. The accompanying claims and their equivalents are intended to cover such forms or modifications as would fall within the scope and sprit of the invention.

What is claimed is:

1. An electronic device, comprising:
a first receiver configured to receive a broadcast program;
a second receiver configured to receive a certain signal from another electronic device;
a first detector configured to detect that the second receiver has received the certain signal from said another electronic device;
a posting information acquiring module configured to acquire a preset posting information, when the first detector detects that the second receiver has received the certain signal from said another device; and
a posting information output module configured to output the preset posting information as posting information of the received broadcast program to a predetermined server.

2. The electronic device of claim 1, further comprising:
a storage module configured to store the preset posting information therein.

3. The electronic device of claim 2, wherein the storage module is configured to store information about the predetermined server as well as the present positing information therein.

4. The electronic device of claim 1, further comprising:
a second detector configured to detect whether the posting information is preset or not.

5. The electronic device of claim 1, wherein said another electronic device is a remote controller having a first operation key,
wherein when the first operation key is operated by a user, the second receiver receives the certain signal from the remote controller.

6. The electronic device of claim 1, wherein the certain signal includes at least one of i) a signal to instruct the electronic device to output the preset posting information to the predetermined server, ii) a signal for turning ON or OFF the electronic device and iii) a signal for changing the received broadcast program.

7. The electronic device of claim 1, further comprising:
a specifying module configured to specify the posting information.

8. An electronic device control method, comprising:
(a) receiving a broadcast program;
(b) receiving a certain signal from another electronic device;
(c) detecting that the certain signal has been received from said another electronic device;
(d) acquiring a preset posting information, when detecting that the certain signal has been received from said another device; and
(e) outputting the preset posting information as posting information of the received broadcast information to a predetermined server.

9. A non-transitory computer-readable medium storing a control program for causing the computer to perform operations comprising:
(a) receiving a broadcast program;
(b) receiving a certain signal from another electronic device;
(c) detecting that the certain signal has been received from said another electronic device;
(d) acquiring a preset posting information, when detecting that the certain signal has been received from said another device; and
(e) outputting the preset posting information as posting information of the received broadcast information to a predetermined server.
